(19) United States
(12) Patent Application Publication
(10) Pub. No.: US 2012/0216536 A1
(43) Pub. Date: Aug. 30, 2012

(54) SUPERCRITICAL CARBON DIOXIDE POWER CYCLE CONFIGURATION FOR USE IN CONCENTRATING SOLAR POWER SYSTEMS

(75) Inventors: Zhiwen Ma, Golden, CO (US); Craig S. Turchi, Golden, CO (US)

(73) Assignee: Alliance For Sustainable Energy, LLC, Golden, CO (US)

(21) Appl. No.: 13/403,661

(22) Filed: Feb. 23, 2012

Related U.S. Application Data
(60) Provisional application No. 61/446,735, filed on Feb. 25, 2011.

(51) Int. Cl. F03G 6/00

(52) U.S. Cl. 60/641.8

(57) ABSTRACT

Methods and solar power generation systems including a working fluid circuit providing for the flow of supercritical carbon dioxide (S-CO₂) therein. The methods and systems may also include a solar energy receiver in thermal communication with the working fluid circuit providing for solar heating of the S-CO₂ working fluid; a power turbine in fluid communication with the S-CO₂; a generator mechanically coupled to the power turbine; a compressor turbine in fluid communication with the S-CO₂ and a compressor mechanically coupled to the compressor turbine such that the compressor is configured to compress the S-CO₂ within a portion of the working fluid circuit. The methods and systems may optionally include a secondary power block in thermal communication with a primary power block. The methods and systems may optionally include thermal energy storage. Various embodiments may be implemented in a modular fashion and located on or within a solar energy tower.

### PRIORITY

This application claims the benefit under 35 USC section 119 of U.S. provisional application 61/446,735 filed on Feb. 25, 2011 and entitled “Supercritical Carbon Dioxide Power Cycle Configurations for Use in Concentrating Solar Power Systems” the content of which is hereby incorporated by reference in its entirety and for all purposes.

### CONTRACTUAL ORIGIN

The United States Government has rights in this invention under Contract No. DE-AC36-08G028308 between the United States Department of Energy and the Alliance for Sustainable Energy, LLC, the manager and operator of the National Renewable Energy Laboratory.

### BACKGROUND

Concentrating Solar Power systems (CSP) utilize solar energy to drive a thermal power cycle for the generation of electricity. CSP technologies include parabolic trough, linear Fresnel, central receiver or “power tower,” and dish/engine systems. Considerable interest in CSP has been driven by renewable energy portfolio standards applicable to energy providers in the southwestern United States and renewable energy feed-in tariffs in Spain. CSP systems are typically deployed as large, centralized power plants to take advantage of economies of scale. A key advantage of certain CSP systems, in particular parabolic troughs and power towers, is the ability to incorporate thermal energy storage. Thermal energy storage is often less expensive and more efficient than electric storage and allows CSP plants to increase capacity factor and dispatch power as needed—for example, to cover evening or other demand peaks.

Current CSP plants typically utilize oil, molten salt or. steam to transfer solar energy from a solar energy collection field, tower or other apparatus to the power generation block. These fluids are generally referred to as “heat transfer fluids” and are typically flowed through heat exchange apparatus to heat water to steam or to heat an alternative “working fluid” which is then used to drive a turbine and generate electrical power. Commonly utilized heat transfer fluids have properties that in certain instances limit plant performance; for example, synthetic oil heat transfer fluid has an upper temperature limit of 390° C., molten salt has an upper temperature limit of about 565° C. while direct steam generation requires complex controls and allows for limited thermal storage capacity. Higher operating temperatures generally translate into higher thermal cycle efficiency and often allow for more efficient thermal storage. However, higher temperatures also require the use of more exotic materials and cause greater optical and thermal losses.

Current CSP plants that rely upon a heat transfer fluid circuit in thermal communication with a separate working fluid circuit necessarily require complex, bulky and costly heat exchange apparatus between the heat transfer and working fluid circuits. In addition, the relatively low density of many working fluids when applied to a turbine (superheated steam for example) requires relatively large turbine blades to accomplish a desired quantity of work. The combination of bulky heat exchange apparatus with large turbine structures causes the power block of most CSP plants to be a large facility which is located away from the solar receiver. For example, the power block in a conventional tower-based CSP facility might be located on the ground away from the solar energy receiver which is situated at the top of a tower.

The embodiments disclosed herein are intended to overcome one or more of the limitations noted above. The foregoing examples of the related art and limitations related therewith are intended to be illustrative and not exclusive. Other limitations of the related art will become apparent to those of skill in the art upon a reading of the specification and a study of the drawings.

### SUMMARY OF THE EMBODIMENTS

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One embodiment is a solar power generation system including a working fluid circuit providing for the flow of supercritical carbon dioxide (S-CO₂) therein. The system also includes a solar energy receiver in thermal communication with the working fluid circuit providing for solar heating of the S-CO₂ working fluid; a power turbine in fluid communication with the S-CO₂; a generator mechanically coupled to the power turbine; a compressor turbine in fluid communication with the S-CO₂ and a compressor mechanically coupled to the compressor turbine such that the compressor is configured to compress the S-CO₂ within a portion of the working fluid circuit.

The solar power generation system may, in selected embodiments, maintain the S-CO₂ within the working fluid circuit without phase change. The above system is therefore configured to provide a Brayton power cycle. The system may include a single power turbine/compressor turbine shaft or the system may include a power turbine shaft and a separate compressor turbine shaft providing for the independent rotation of the power turbine and the compressor turbine. The system further includes at least one recuperator in thermal communication with the S-CO₂ working fluid.

In one possible embodiment, the solar energy receiver, working fluid circuit, power turbine, generator, compressor turbine, compressor, and at least one recuperator are each located within or on a tower. In an alternative embodiment selected apparatus may be located near, but separate from the tower.

The solar power generation system may optionally include a thermal energy storage system in thermal communication with the S-CO₂ working fluid. In this alternative configuration, the S-CO₂ functions as a working fluid and a heat transfer fluid.

An alternative system embodiment includes a primary Brayton power block utilizing S-CO₂ working fluid as described above and a secondary, typically Rankine cycle, power block associated with the primary power block. Such an alternative system includes but is not limited to a heat exchanger in thermal communication with the primary working fluid circuit downstream from the power turbine; a secondary working fluid circuit containing a secondary working fluid in thermal communication with the heat exchanger; a secondary power turbine in fluid communication with the secondary working fluid; and a secondary generator mechanically coupled to the secondary power turbine.

The secondary working fluid may be any suitable fluid including water/steam or an organic fluid. In certain embodiments of a system featuring a secondary power block the solar energy receiver, working fluid circuit, power turbine, generator, compressor turbine, compressor, heat exchanger, secondary working fluid circuit, secondary power turbine and secondary generator are each located within or on a tower.

Another alternative system embodiment is a solar power generation system comprising a working fluid circuit providing for the flow of S-CO₂ therein; a solar energy receiver in thermal communication with the working fluid circuit providing for solar heating of the S-CO₂ working fluid and a Brayton cycle power block in fluid communication with the S-CO₂. This alternative embodiment may optionally include a Rankine cycle power block in thermal communication with the Brayton cycle power block. Either of the above variations may optionally be configured such that all receiver and power block apparatus is located on or in a tower. The foregoing embodiments may optionally include a thermal energy storage system in thermal communication with the S-CO₂.

Another alternative embodiment is a method of generating electricity from solar energy. The method includes at least the steps of providing a working fluid circuit having S-CO₂ flowing therein, the working fluid circuit being in fluid communication with a solar energy receiver, a power turbine, a compressor turbine and a compressor. The method further includes the steps of flowing S-CO₂ through the solar energy receiver causing the S-CO₂ to be heated with concentrated solar energy; flowing heated S-CO₂ from the receiver through the power turbine and the compressor turbine causing the power turbine to rotate and drive a generator to generate electrical current. The method also uses heated S-CO₂ to cause the compressor turbine to rotate to drive the compressor. Thus, S-CO₂ from the power turbine may be flowed through the compressor causing compression of the S-CO₂.

The foregoing method embodiment further includes cooling the S-CO₂ flowing from the power turbine to the compressor with at least one recuperator. In some embodiments the power turbine may be caused to rotate at a first selected speed and the compressor turbine may be rotated at a second selected speed which is different from the first selected speed. S-CO₂ may optionally be flowed through a thermal energy storage system.

An alternative method includes the above steps plus the steps of flowing the S-CO₂ through a heat exchanger in thermal communication with a secondary working fluid circuit and flowing the secondary working fluid through a secondary power turbine to rotate and drive a secondary generator to generate electrical current.

Another alternative method of generating electricity from solar energy includes providing a working fluid circuit having S-CO₂ flowing therein, the working fluid circuit being in fluid communication with a solar energy receiver, and a Brayton cycle power block, this embodiment includes the steps of flowing S-CO₂ through the solar energy receiver causing the S-CO₂ to be heated with concentrated solar energy and flowing heated S-CO₂ from the receiver through the Brayton cycle power block to drive a generator to generate electrical current. This method may optionally include the steps of flowing S-CO₂ through a heat exchanger to heat a secondary working fluid in a secondary working fluid circuit and flowing heated secondary working fluid from the heat exchanger through a Rankine cycle power block to drive a secondary generator to generate electrical current.

In addition to the exemplary aspects and embodiments described above, further aspects and embodiments will become apparent by reference to the drawings and by study of the following descriptions.

### BRIEF DESCRIPTION OF THE DRAWINGS

Exemplary embodiments are illustrated in referenced figures of the drawings. It is intended that the embodiments and figures disclosed herein are to be considered illustrative rather than limiting.

FIG. 1 is a functional block diagram showing a concentrating solar power electrical generating system as disclosed.

FIG. 2 is a schematic diagram showing a possible orientation of the apparatus of FIG. 1 within a tower.

FIG. 3 is a functional block diagram showing an alternative concentrating solar power electrical generating system as disclosed.

FIG. 4 is a flow chart illustration of a method for generating electricity from concentrated solar energy as disclosed.

FIG. 5 is a flow chart illustration of an alternative method for generating electricity from concentrated solar energy as disclosed.

### DETAILED DESCRIPTION

Unless otherwise indicated, all numbers expressing quantities of ingredients, dimensions, reaction conditions and so forth used in the specification and claims are to be understood as being modified in all instances by the term “about”.

In this application and the claims, the use of the singular includes the plural unless specifically stated otherwise. In addition, use of “or” means “and/or” unless stated otherwise. Moreover, the use of the term “including”, as well as other forms, such as “includes” and “included”, is not limiting. Also, terms such as “element” or “component” encompass both elements and components comprising one unit and elements and components that comprise more than one unit unless specifically stated otherwise.

The following disclosure relates to concentrating solar power (CSP) systems and methods. Various embodiments disclosed herein feature solar heated supercritical carbon dioxide (S-CO₂) as the working fluid CSP power block. In certain alternative embodiments the S-CO₂ may also function as a heat transfer fluid. Generally, a CSP working fluid expands within or before a turbine to perform work, for example electrical generation or fluid compression. Generally, a heat transfer fluid exchanges thermal energy with another substance, for example, a working fluid or a thermal energy storage material.

As used herein, supercritical carbon dioxide (S-CO₂) is defined as a fluid state of carbon dioxide held at or above its critical temperature and critical pressure. Carbon dioxide usually behaves as a gas in air at standard temperature and pressure (STP) or as a solid “dry ice” when frozen. If the temperature and pressure of carbon dioxide are both increased from STP to be at or above the critical point for carbon dioxide, the material can adopt properties midway between a gas and a liquid. More specifically, carbon dioxide behaves as a supercritical fluid above its critical temperature (31.1° C.) and critical pressure (72.9 atm or 7.39 MPa). S-CO₂ expands to fill its container like a gas but has a density similar to that of a liquid.

Various embodiments disclosed herein feature S-CO₂ as the working fluid in a closed-loop recompression Brayton cycle power block. These embodiments offer the potential of equivalent or higher cycle efficiency versus supercritical or superheated steam working cycles at temperatures relevant for CSP applications.

In selected embodiments S-CO₂ is utilized in a single phase process as both heat transfer fluid (HTF) and thermal power cycle working fluid. As detailed below, the dual functionality of S-CO₂ simplifies power system configuration. The embodiments disclosed herein are also compatible with sensible or latent heat thermal energy storage based upon heat exchange with a thermal energy storage material. The simpler machinery and compact size of the S-CO₂ apparatus disclosed herein may reduce the installation, maintenance and operation cost of a system of given size. In particular, Brayton-cycle systems using S-CO₂ as working fluid can be designed to have smaller weight and volume, lower thermal mass and less complex power blocks versus Rankine cycle based systems due to the higher density of the S-CO₂ working fluid and simpler cycle design. The lower thermal mass of various embodiments also makes startup and load change faster for frequent start up/shut down operations and load adaption when compared to a conventional HTF/steam based systems.

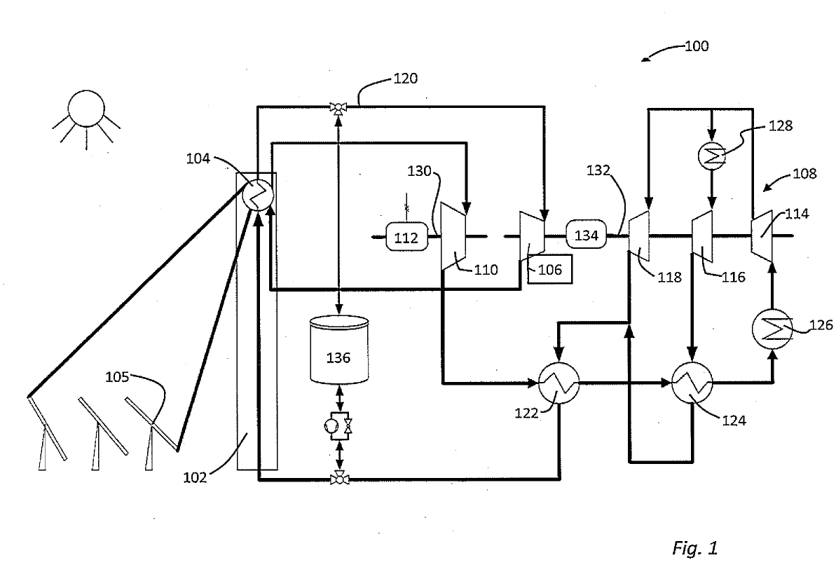

FIG. 1 is a schematic block-diagram illustration of a modular tower and receiver S-CO₂ Brayton cycle solar thermal power system. In selected embodiments, the CSP system 100 of FIG. 1 uses S-CO₂ without thermal energy storage. In other embodiments thermal energy storage or a secondary power block are included and S-CO₂ is used as both heat transfer fluid and working fluid. The assumed capacity of the power block as illustrated In FIG. 1 is approximately 5 to 10 MW, although the plant illustrated in FIG. 1 can be scaled as desired to accommodate different power generation needs. Each tower 102 could house its own turbo-machinery and multiple towers could be assembled in a single power park. Alternatively a tower could house the apparatus associated with a solar receiver and each tower could be connected to power block apparatus located nearby.

The FIG. 1 configuration includes a receiver 104 that is positioned to receive concentrated solar irradiation reflected from many, often hundreds or thousands, of mirrors or heliostats 105. The system 100 also includes a compressor turbine 106 to drive an S-CO₂ compressor assembly 108 and a power turbine 110 to drive a generator 112. The S-CO₂ compressor assembly can include multiple stages if desired, including but not limited to pre-compressor 114, main compressor 116 and re-compressor 118.

The receiver 104 is in thermal communication with a working fluid circuit 120 which has S-CO₂ flowing therein as working fluid. Thus, concentrated sunlight reflected from the heliostats 105 is received at the receiver 104 and heats the S-CO₂ to an operational temperature. The remaining elements described above and other elements described below are in fluid communication with the S-CO₂ flowing within the working fluid circuit 120 or in certain instances in thermal communication with the S-CO₂working fluid.

For example, in the FIG. 1 embodiment, heated S-CO₂ flows from the receiver 104 in the working fluid circuit 120 to the power turbine 110. At or in the power turbine, the S-CO₂ expands to drive the power turbine 110. The power turbine 110 is mechanically coupled to a generator 112 and thus electrical power is generated by the generator 112 when the power turbine 110 is driven.

S-CO₂ exits the power turbine 110 at a lower temperature and pressure than present at the power turbine inlet. To complete a Brayton power cycle the S-CO₂ must be further cooled and re-pressurized before it is re-heated at the receiver 104. Thus, S-CO₂ exiting the power turbine flows through one or more recuperators, for example high temperature recuperator 122 and low temperature recuperator 124. One or more supplemental pre-coolers, for example pre-coolers 126 and 128 may further cool the S-CO₂ prior to compression of the super-critical working fluid in the compressor 108. As noted above the compressor system 108 is driven by compressor turbine 106 and may be implemented with multiple stages including but not limited to pre-compressor 114, main compressor 116 and re-compressor 118.

After compression, the pressurized S-CO₂ working fluid may be flowed back to the receiver 104 for heating. It may be noted from FIG. 1 that the recuperators 122 and 124 also serve to pre-heat the compressed S-CO₂ prior to final heating at the receiver 104.

Accordingly, the system 100 of FIG. 1 uses S-CO₂ as the working fluid in a closed system recompression Brayton cycle power generation block. In the system 100, S-CO₂ is maintained throughout the cycle in the supercritical state, without phase change. Alternative embodiments might include condensing cycles that cause the S-CO₂ to phase-change to a liquid. The high efficiency of S-CO₂ Brayton cycle is achieved by recuperating heat from the turbine exhaust side back to the high-pressure S-CO₂ flow. Proper recuperation requires significant heat transfer and therefore large heat exchanger area. Large, high-pressure heat exchangers such as recuperators 122 and 124 could be costly. A smaller scale system 100 can make recuperator selection and design somewhat easier, but optimization of the recuperator elements will be important in lowering the cost and increasing the performance of the system 100.

The power block of the system 100 features a dual shaft design that separates gas compression and power generation. It is important to note that alternative embodiments may feature a single shaft which enhances fabrication simplicity and minimizes capital cost at the expense of operational flexibility. If a dual shaft embodiment is installed. One benefit is that the power turbine shaft 130 and gas compressor shaft 132 can run at differing speeds. In particular, the compressor 108 can be run at a speed selected to maximize compression efficiency while the power turbine 110 can be run at constant speed in synchronization with the power grid frequency.

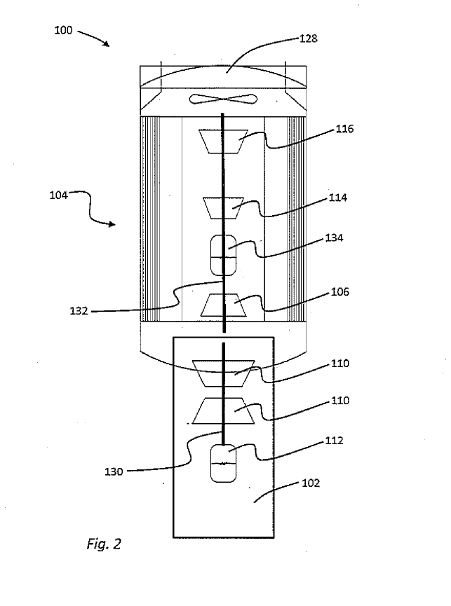

An alternative face-to-face layout of twin power turbines 110 (see FIG. 2) may be utilized to cancel the thrust force exerted on the bearings of the power turbine shaft 130. Similarly, the compressor turbine 106 and various compressor components 114-118 may be positioned in a face-to-face layout to thrust balance the compressor shaft 132. A motor and brake system 134 may optionally be associated with the compressor shaft 132 to help start and stop the compressor and compressor turbine units.

Because of the compact mechanical form achievable with a single phase S-CO₂ turbine/compressor system 100, it is possible to reduce the size of the generation unit and incorporate the system within a single housing if desired and integrate the generation unit into the receiver 104 and tower 102 portions of a receiver/tower assembly as depicted in FIG. 2. The benefits of integrating the entire system within a tower include shorter piping and thus reduced pressure losses, reduced thermal losses, and improved transient response. As a result, an integrated tower based system may achieve high performance and significant cost benefits for CSP power generation.

One possible set of dimensions and operational parameters for a 10 MW integrated tower based S-CO₂ system 100 are given in Table 1. The final selected turbine/compressor size depends on power rating and design parameters, such as compression ratio, shaft speed, and operational considerations such as the selection of axial or radial flow for the compressor and turbine.

TABLE 1
Typical Parameters for 10 MW S—CO₂ power unit

| | |
|---|---|
| Turbine diameter | 21 cm (8.3 in) |
| Flow rate | 125 kg/s |
| Temperature, pressure | 700° C., 250 bars |
| HTF piping size | 8″ @ 30 m/s |

It is important to note that the system 100 described in detail above may be implemented with a greater or lesser number of components selected to achieve efficient energy generation utilizing S-CO₂ as the working fluid of a Brayton cycle power block. The various embodiments disclosed herein are not limited to the precise configuration of FIG. 1 or 2.

As noted above, the modular and integrated power block design of FIG. 2 features a dual-shaft turbine layout to separate gas compression and power generation shafts 130 and 132. Although single shaft embodiments are within the scope of this disclosure and are simpler and thus less costly, a dual shaft configuration provides for compression stages and power generation to be run at different shaft speeds with each shaft speed selected to achieve optimum operational conditions. For example, the power turbine 110 and power turbine shaft may be rotated at a speed 3600 rpm which matches the grid power frequency of 60 Hz when using many typical generator designs. In other implementations, as noted in Table 2 below, it may be advantageous to rotate the power turbine at a higher speed. In a higher-speed implementation the system may include a gearbox between the power turbine and generator to assure that the generator operates at the correct rotational speed.

The compressor 108 and compressor turbine 106 may be run at much higher speeds for better efficiency. Selecting a relatively high shaft speed for the compressor 108 and compressor turbine 106 reduces the sizes of these components and improves performance, as indicated in Table 2.

TABLE 2
Selected Parameters for Systems of Various Power Ratings

| Power | Turbine | Desired | |
|---|---|---|---|
| Rate | Wheel | Shaft Speed | CO₂ Flow |
| (MW) | diameter (m) | (RPM) | (kg/sec) |
| 0.3 | 0.04 | 125,000 | 3.5 |
| 3 | 0.15 | 50,000 | 35 |
| 300 | 1.5 | 3,600 | 3500 |

Table 2 shows the turbine size, shaft speed, and CO₂ mass flow rate for systems having a power rating of 0.3, 3 and 300 MW. For example, a 3 MW system can be designed to have a 15 cm (6 inch) power turbine operating with a shaft speed of 50,000 RPM. An apparatus of this size may readily be located within a tower and associated with a solar receiver 104 as depicted in FIG. 2.

An alternative embodiment of the system 100 which includes thermal energy storage is also shown in FIG. 1. Thermal energy storage enhances the basic system 100 described above by providing for extended power generation at times when sunlight is blocked by clouds or into the evening. Thus, a modular S-CO₂ system plus thermal energy storage (TES) can reduce the impact of weather conditions on generation variability. Implementation of a large TES for longer storage hours may shift generation to accommodate peak hours or allow for continuous power generation. Unlike the working fluid used in water/steam Rankine cycle based systems, S-CO₂ undergoes no phase change during heat transfer and can be matched to currently available molten salt TES technology. Using the system 100 as a starting point, an enhanced TES system adds a TES system 136 to store solar energy for use during peak demand or under no-solar heat conditions. The TES system 136 would possibly be ground-mounted and shared between towers. Utilization of a TES system 136 can provide short term storage for weather transition and load shift simply and economically.

Any type of TES can be adapted for use with the system 100, provided the selected TES is designed to properly exchange heat energy with the S-CO₂ working fluid of the described embodiments. Thus, in an alternative implementation where the system 100 includes a TES system 136, the S-CO₂ functions as both working fluid and heat transfer fluid. One representative but non-limiting example of a TES 136 suitable for implementation in conjunction with system 100 is a two tank system utilizing molten salt as a heat storage material. A two-tank salt system maintains hot and cold salt in separate tanks. During discharge, the salt is pumped from a hot tank to a cold tank through heat exchangers that exchange heat from the hot molten salt to the S-CO₂ flowing in the working fluid circuit 120. The process is reversed during charging such that heat is transferred to the molten salt from the S-CO₂ which is functioning as a heat transfer fluid (HTF). Generally, any TES configurations will provide for several operational modes including a generation mode where all HTF is used for power generation and compressor operation, a charge mode where HTF is sent to the storage system and heat is stored in the thermal energy storage tank(s) and a discharge mode where the power block is driven by the thermal energy from the storage tank instead of heat from solar receiver.

The shortcomings of a two-tank salt system include high system and material costs and a temperature cap (less than 600° C.) for salt stability when implemented with a sodium/potassium nitrate salt blend as is typical in known liquid salt TES implementations. Other TES technologies under development involve thermocline TES, TES utilizing the latent heat of phase-change materials, or TES systems utilizing other low-cost; stable heat storage materials for high performance and more economical operations. Low-cost high-temperature storage can improve the described S-CO₂ system overall efficiency, increase capacity factor and reduce cost. A suitable TES 136 system could be integrated into the tower to minimize S-CO₂ pipe runs. Alternatively, a suitable TES system 136 may be ground mounted and feature a molten salt heat storage material which is pumped to multiple towers.

For high temperature storage, thermal storage materials other than nitrate salts may be necessary for stability and high energy density, for instance, salt or metal alloys with phase-change temperatures matching the S-CO₂ temperature range, solid storage media, or a high temperature salt or metal. Since S-CO₂ cycles are highly recuperated and the turbine expansion ratio is limited, the temperature window for a suitable heat source is narrow. This operational consideration limits the utility of sensible heat storage systems in combination with a S-CO₂ system such as system 100. A supplemental power block cycle such as described in detail below may be considered to expand the heat source temperature difference by lowering the returning temperature of S-CO₂ flowing back to the receiver 104. Alternatively a phase-change TES system may be deployed that operates over a more narrow temperature window. Aluminum and aluminum alloys are promising candidates with large heats-of-fusion in the 550 to 700° C. range. The use of a metallic alloy also eliminates the thermal conductivity limitations experienced with salt phase change materials.

In an S-CO₂ Brayton cycle system 100 as described above, a major cost of the components may not be the turbine and compressor elements, as these components can be relatively small and somewhat economical to produce. On the contrary, a significant cost associated with a system 100 would be associated with the heat recuperator(s) 122 and 124 and pre-cooler(s) 126, 128, as these heat exchange elements are subject to very high pressure differentials. One way to mitigate this cost is to add a “bottom” or secondary power cycle to the system. For example the system may be expanded to include a Rankine cycle or in particular an Organic Rankine Cycle (ORC) power block to minimize the physical size necessary to accommodate the large temperature and pressure gradients present in the recuperator and pre-cooler elements. Adding an ORC power block may also be beneficial to an S-CO₂ Brayton cycle system by potentially converting up to 20% of the waste heat from the Brayton cycle power block into electricity, which increases overall cycle efficiency. The combined Brayton cycle/Rankine cycle plant may thus compares favorably in both performance and cost to other known types of CSP power block configurations.

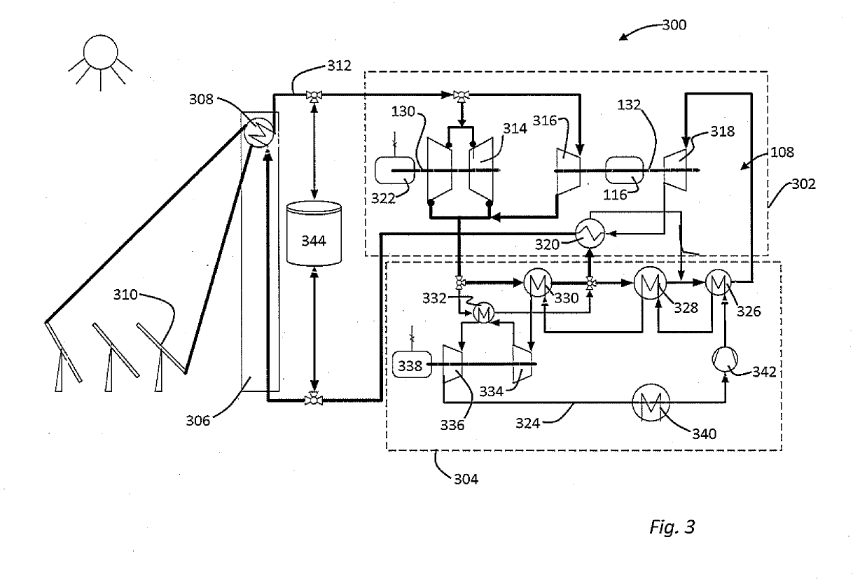

A representative but non-limiting example of a system 300 featuring an S-CO₂ upper Brayton cycle power block 302 and a lower Rankine cycle power block 304 is shown in FIG. 3. The system 300 of FIG. 3 offers several advantages over conventional CSP configurations, including but not limited to; increased efficiency by avoiding oil or salt HTF-temperature limitations, a modular design that maximizes factory manufacturing to reduce component cost, shorten plant construction time and reduce installation cost, higher thermal conversion efficiency and reduced system complexity by using S-CO₂ as both HTF and working fluid. A combined cycle system 300 can obtain high cycle efficiency of about 50-60%, and commensurate 30-40% solar-to-electricity efficiency.

The system 300 is modular and can be integrated with a tower in a manner similar to the system 100 of FIG. 2. Thus, the system 300 includes a tower 306, solar energy receiver 308 and heliostats 310 all functioning as described above. The receiver 308 is in thermal communication with an upper Brayton power block 302 through the primary working fluid circuit 312 having S-CO₂ flowing therein as described above. The primary working fluid circuit 312 is in fluid communication with one or more power turbines 314, one or more compressor turbines 316, compressor elements 318, and a recuperator 320. The foregoing elements function as described above with respect to FIG. 1 and FIG. 2 to utilize a Brayton cycle to drive the power turbines 314 and thus generate electrical power with a primary generator 322.

The system 300 also includes a lower, secondary, Rankine power block 304. The Rankine power block 304 includes a secondary working fluid circuit 324 having a secondary working fluid flowing therein. The secondary working fluid may, for example, be water/steam or an organic working fluid. During operation, the secondary working fluid is heated by heat exchange with S-CO₂ flowing in the primary working fluid circuit 312. Heat exchange between the primary S-CO₂ working fluid and the secondary working fluid may occur in any suitable heat exchanging apparatus including but not limited to the preheater 326, evaporator 328, superheater 330 and reheater 332 of FIG. 3.

As further illustrated in FIG. 3, heated secondary working fluid exits the superheater 330 and/or reheater 332 to drive secondary power turbines, for example high pressure turbine 334 and low pressure turbine 336. The secondary power turbines 334, 336 are in turn mechanically coupled to secondary generator 338 and are configured to drive the secondary generator 338 to produce electricity. Secondary working fluid in a gas phase may exit the power turbines 334 and 336 and be condensed to a liquid in a condenser 340. The condensed liquid may then be pumped back through the Rankine power block 304 by pump 342.

As noted above, a system 300 including a lower Rankine power block 304 is advantageous in at least three ways. First, the waste heat from the upper Brayton cycle power block 302 is captured and used to generate electricity. Second, S-CO₂ primary working fluid undergoes temperature reduction as heat is exchanged with the secondary working fluid circuit 324. Thus, proper Brayton cycle operation may be maintained with relatively smaller and less expensive recuperator 320 elements. Finally, the expanded temperature differential in the S-CO₂ primary working fluid circuit 312 facilitates sensible heat thermal energy storage if desired.

The system 300 can also be implemented with an optional TES system 344 as described above. Furthermore, because of the compact mechanical form achievable with a single phase S-CO₂ Brayton cycle power block 302, it is possible to reduce the size of the entire generation unit and integrate the generation unit into a receiver/tower assembly 306, 308. The benefits of integrating the entire system 300 with a tower include shorter piping and thus reduced pressure loss, reduced thermal loss, and improved transient response. As a result, an integrated tower based system may achieve high performance and significant cost benefits for CSP power generation. Alternatively, the Brayton cycle power block 302 may be incorporated into a tower with heat exchange between several towers and a lesser number of Rankine power blocks 304 occurring at a ground-based secondary plant.

Table 3 compares the gross cycle efficiency of a simple recuperated S-CO₂ Brayton cycle system and a recompression S-CO₂ Brayton cycle system versus a typical subcritical reheat steam cycle as used in a power tower. The tabulated steam values are based upon a wet-cooled, direct steam receiver system. The simple S-CO₂ cycle provides an improvement relative to the current state-of-the-art if higher operating temperatures are employed, while the more complex recompression cycle achieves substantially higher efficiencies even at comparable temperatures.

TABLE 3
Estimated efficiency for selected S—CO₂ power cycles

| | Turbine Inlet | |
|---|---|---|
| | Temperature, | Gross Cycle |
| | ° C. | Efficiency |
| Steam (subcritical steam | 585 | 43.5% |
| receiver with wet cooling and | | |
| reheat) | | |
| Simple Cycle S—CO2 | 550 | 40.4% |
| | 700 | 45.5% |
| Recompression Cycle S—CO₂ | 550 | 46.5% |
| | 700 | 51.2% |

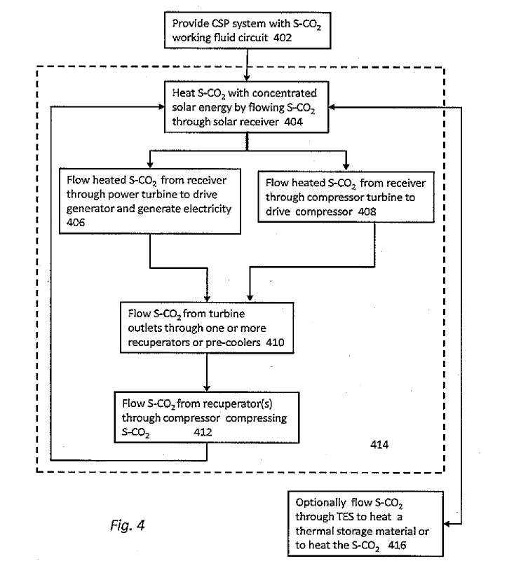

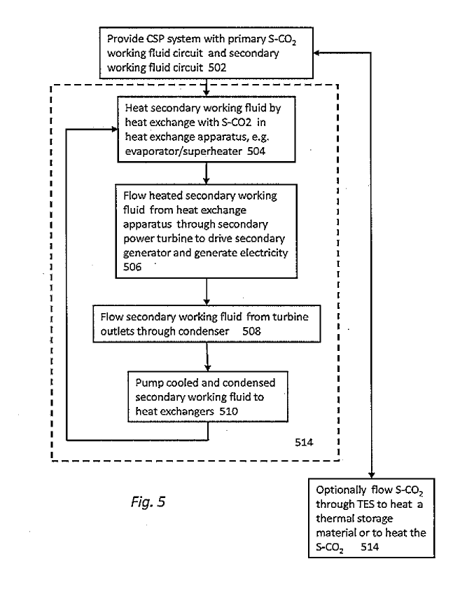

Alternative embodiments include methods of generating electricity from solar energy. Representative, non-exclusive methods are illustrated in the flow charts of FIGS. 4 and 5. For example, FIG. 4 illustrates a method of generating electricity using concentrated solar energy based upon a CSP system as described above having an S-CO₂ working fluid circuit (step 402). The method includes the step of heating the S-CO₂ by flowing the S-CO₂ through a concentrated solar energy receiver (step 404). A portion of the heated S-CO₂ may then be used to drive a power turbine which is mechanically coupled to a generator to generate electricity (step 406). Another portion of the S-CO₂ may be used to drive a compressor turbine coupled to a compressor or multi-stage compression apparatus (step 408). S-CO₂ exiting the turbines is somewhat less pressurized and somewhat less heated than the S-CO₂ at a turbine entrance, however the S-CO₂ must be further cooled and pressurized prior to return to the receiver. Therefore the S-CO₂ may be flowed through one or more recuperators or pre-coolers prior to compression (step 410). The S-CO₂ may then be compressed and the pressurized S-CO₂ returned to the receiver for heating (step 412).

The foregoing steps 404-412 provide for a Brayton power cycle 414. As described in detail above, the method may optionally include flowing the S-CO₂ working fluid to and from a thermal energy storage system to provide thermal energy storage (step 416).

The method of FIG. 4 may optionally be supplemented with a secondary power cycle. In particular, with an S-CO₂ Brayton cycle as described above, a major cost of the apparatus may be associated with the heat recuperator(s) and pre-cooler(s) used in step 410. One way to mitigate this cost is to add a “bottom” or secondary power block to the system. For example the system may be expanded to include a Rankine cycle or in particular an Organic Rankine Cycle (ORC) power block to minimize the physical size necessary to accommodate the large temperature and pressure gradients present in the recuperator and pre-cooler elements. Accordingly, FIG. 5 illustrates a method where the S-CO₂ circuit described above constitutes a primary working fluid circuit and the CSP system also includes a secondary working fluid circuit (step 502). The secondary working fluid may be heated to operational temperatures by heat exchange with the S-CO₂ working fluid in dedicated heat exchange apparatus including but not limited to preheater, evaporator, superheater or repeater apparatus (step 504). The heated secondary working fluid may then be applied to a secondary power turbine to drive a secondary generator and thus generate electricity (step 506). The secondary working fluid may then be taken from the secondary turbine outlet and condensed in a condenser (step 508). The secondary working fluid may then be pumped back to the heat exchange elements for reheating (step 510). Thus, steps 504-510 provide for an optional secondary Rankine power cycle 514 which may be used to supplement the method of FIG. 4. The method of FIG. 5 may optionally include flowing the primary S-CO₂ working fluid to and from a thermal energy storage system to provide thermal energy storage (step 514).

Various embodiments of the disclosure could also include permutations of the various elements recited in the claims as if each dependent claim was a multiple dependent claim incorporating the limitations of each of the preceding dependent claims as well as the independent claims. Such permutations are expressly within the scope of this disclosure.

While a number of exemplary aspects and embodiments have been discussed above, those of skill in the art will recognize certain modifications, permutations, additions and sub combinations thereof. It is therefore intended that the following appended claims and claims hereafter introduced are interpreted to include all such modifications, permutations, additions and sub-combinations as are within their true spirit and scope.

What is claimed is:

1. A solar power generation system comprising:
a working fluid circuit configured for. the flow of supercritical carbon dioxide therein;
a solar energy receiver in thermal communication with the working fluid circuit configured to provide for solar heating of the supercritical carbon dioxide within the working fluid circuit;
a power turbine in fluid communication with the supercritical carbon dioxide within the working fluid circuit;
a generator mechanically coupled to the power turbine;
a compressor turbine in fluid communication with the supercritical carbon dioxide within the working fluid circuit; and
a compressor mechanically coupled to the compressor turbine, wherein the compressor is further in fluid communication with the supercritical carbon dioxide within the working fluid circuit.

2. The solar power generation system according to claim 1, wherein the supercritical carbon dioxide within the working fluid circuit is maintained without phase change.

3. The solar power generation system according to claim 1 further comprising a power turbine shaft and a separate compressor turbine shaft providing for the independent rotation of the power turbine and the compressor turbine.

4. The solar power generation system according to claim 1 further comprising at least one recuperator in thermal communication with the supercritical carbon dioxide within the working fluid circuit.

5. The solar power generation system according to claim 1, wherein the solar energy receiver, working fluid circuit, power turbine, generator, compressor turbine compressor, and at least one recuperator are each located within a tower.

6. The solar power generation system according to claim 1 further comprising a thermal energy storage system in thermal communication with the supercritical carbon dioxide within the working fluid circuit and wherein the supercritical carbon dioxide functions as a working fluid and a heat transfer fluid.

7. The solar power generation system according to claim 1 further comprising:
a heat exchanger in thermal communication with the working fluid circuit downstream from the power turbine;
a secondary working fluid circuit containing a secondary working fluid in thermal communication with the heat exchanger;
a secondary power turbine in fluid communication with the secondary working fluid; and
a secondary generator mechanically coupled to the secondary power turbine.

8. The solar power generation system according to claim 7, wherein the secondary working fluid comprises an organic fluid.

9. The solar power generation system according to claim 7, wherein the secondary working fluid comprises water.

10. The solar power generation system according to claim 7, wherein the solar energy receiver, working fluid circuit, power turbine, generator, compressor turbine, compressor, heat exchanger, secondary working fluid circuit, secondary power turbine and secondary generator are each are each located within a tower.

11. The solar power generation system of claim 7 further comprising a thermal energy storage system in thermal communication with the supercritical carbon dioxide within the working fluid circuit and wherein the supercritical carbon dioxide functions as a working fluid and a heat transfer fluid.

12. A solar power generation system comprising:
a working fluid circuit configured for the flow of supercritical carbon dioxide therein;
a solar energy receiver in thermal communication with the working fluid circuit configured to provide for solar heating of the supercritical carbon dioxide within the working fluid circuit; and
a Brayton cycle power block in fluid communication with the supercritical carbon dioxide within the working fluid circuit.

13. The solar power generation system according to claim 12 further comprising a tower supporting the working fluid circuit, the solar energy receiver and the Brayton cycle power block.

14. The solar power generation system according to claim 12 further comprising a Rankine cycle power block in thermal communication with the supercritical carbon dioxide within the working fluid circuit.

15. The solar power generation system according to claim 14 further comprising a tower supporting the working fluid circuit, the solar energy receiver, the Brayton cycle power block and the Rankine cycle power block.

16. The solar power generation system according to claim 12 further comprising a thermal energy storage system in thermal communication with the supercritical carbon dioxide within the working fluid circuit and wherein the supercritical carbon dioxide functions as a working fluid and a heat transfer fluid.

17. A method of generating electricity from solar energy comprising:
providing a working fluid circuit having supercritical carbon dioxide flowing therein, the working fluid circuit being in fluid communication with:
a solar energy receiver,
a power turbine,
a compressor turbine and
a compressor;
flowing supercritical carbon dioxide through the solar energy receiver causing the supercritical carbon dioxide to be heated with concentrated solar energy;
flowing heated supercritical carbon dioxide from the solar energy receiver through the power turbine and the compressor turbine causing the power turbine to rotate and drive a generator to generate electrical current and causing the compressor turbine to rotate to drive the compressor; and
flowing supercritical carbon dioxide from the power turbine through the compressor causing compression of the supercritical carbon dioxide.

18. The method of generating electricity from solar energy according to claim 16 further comprising cooling the supercritical carbon dioxide flowing from the power turbine to the compressor by flowing the supercritical carbon dioxide through at least one recuperator.

19. The method of generating electricity from solar energy according to claim 16 further comprising causing the power turbine to rotate at a first predetermined speed and causing the compressor turbine to rotate at a second predetermined speed that is different from the first predetermined speed.

20. The method of generating electricity from solar energy according to claim 16 further comprising flowing the supercritical carbon dioxide through a thermal energy storage system.

21. The method of generating electricity from solar energy according to claim 16 further comprising:
flowing the supercritical carbon dioxide through a heat exchanger in thermal communication with a secondary working fluid circuit having a secondary working fluid; and
flowing the secondary working fluid through a secondary power turbine to rotate and drive a secondary generator to generate electrical current.

22. A method of generating electricity from solar energy comprising:
providing a working fluid circuit having supercritical carbon dioxide flowing therein, the working fluid circuit being in fluid communication with:
a solar energy receiver, and
a Brayton cycle power block,
flowing supercritical carbon dioxide through the solar energy receiver causing the supercritical carbon dioxide to be heated with concentrated solar energy; and
flowing heated supercritical carbon dioxide from the solar energy receiver through the Brayton cycle power block to drive a generator to generate electrical current.

23. The method of generating electricity from solar energy according to claim 22 further comprising: flowing supercritical carbon dioxide through a heat exchanger and heating a secondary working fluid in a secondary working fluid circuit; and flowing heated secondary working fluid from the heat exchanger through a Rankine cycle power block to drive a secondary generator to generate electrical current.

24. The method of generating electricity from solar energy according to claim 22 further comprising flowing the supercritical carbon dioxide through a thermal energy storage system.
